(19) United States
(12) Patent Application Publication
(10) Pub. No.: US 2007/0054253 A1
(43) Pub. Date: Mar. 8, 2007

(54) Indicator, method of teaching massage operation and method of massage operation

(76) Inventors: Nobuaki Imanishi, Tokyo (JP); Hideo Nakajima, Tokyo (JP); Junko Tougou, Tokyo (JP)

Correspondence Address: LOWE HAUPTMAN BERNER, LLP, 1700 DIAGONAL ROAD, SUITE 300, ALEXANDRIA, VA, 22314, US

(21) Appl. No.: 10/547,757

(22) PCT Filed: Mar. 3, 2004
(86) PCT No.: PCT/JP04/02603

§ 371 Date: May 30, 2006

(30) Foreign Application Priority Data
Mar. 3, 2003 (JP) 2003-103379
Apr. 16, 2003 (JP) 2003-145502
Mar. 1, 2004 (JP) 2004-056863

(51) Int. Cl. G09B 23/28

(52) U.S. Cl. 434/262

(57) ABSTRACT

This invention provides illustrations that can be used as educational materials for teaching massage treatment, dermatological therapeutic techniques, dermatological diagnostics, etc.; and methods of performing and teaching massage treatment, based on new anatomical findings about cutaneous blood vessels. The illustrations have a 1st illustration, which displays anatomical characteristics of the skin, including the position and state of the cutaneous veins and valves within the veins. The method of teaching the massage treatment uses the aforesaid illustrations as teaching materials. The massage treatment includes a procedure (A) that comprises pressing, towards their respective plexuses, the thin vessels ascending from the deep dermal venous plexus and/or the subdermal venous plexus, which are formed in the deep dermal layer and/or immediately below the dermis by veins unaccompanied by arteries.

### FIELD OF THE INVENTION

The present invention relates to illustrations, methods of teaching massage treatment, and methods of massaging. To be more specific, the present invention relates to illustrations that can be used as educational materials for teaching not only massage treatment but also dermatological therapeutic techniques, dermatological diagnostics, etc., and methods of teaching massage treatment and giving massage treatment using such illustrations.

### BACKGROUND OF THE INVENTION

Massage is a cosmetic treatment that involves manual manipulation of the skin, and it is known to yield beneficial effects like improving stagnant blood flow, generating a feeling of well-being, and reducing swelling. However, effectiveness of the treatment differs significantly, depending on the skill of a massage giver, and certain aspects of mechanisms through which the effects of the treatment are manifested are not understood. Therefore, efforts are now being made to standardize techniques used so that a certain level of effectiveness can be ensured. Examples of such standardization are pressing of acupressure points located in shallow depressions near the medial angles of the eyes and the medial ends of the eyebrows for promoting fat metabolism (see, for instance, Patent Document 1), and techniques like “stroking,” “tapping,” etc. with application of a cosmetic formulation containing a suppressant of new capillary formation (see, for instance, Patent Document 2). Aside from this, massaging technique of rubbing first along the direction of blood flow in the arteries and then along the direction of blood flow in the veins after a hot water bath, while applying cosmetic formulations containing disintegrating particles (see, for instance, Patent Document 3), and massaging technique of repeatedly expanding and shrinking expandable bags to apply pressure to blood vessels to improve blood flow (see, for instance, Patent Document 4) are also known. However, blood flow cannot be improved by simply applying physical pressure on blood vessels because the blood vessels are elastic and because valves in them would stop the flow of blood. In applying such procedures also, there is significant difference in the effects, depending on the skill of a person applying them, and there seem to be many hidden factors that affect effectiveness of massage.

On the other hand, regarding the structure of blood vessels in and near the skin, their distribution is shown, for instance, in Non-Patent Documents 1 and 2. As such, location information about blood vessels is already available. However, it can be said that almost nothing is known about mechanisms of blood flow control, such as locations of valves in the veins, and even the approximate paths of blood flow. Anatomical elucidation of veins close to the skin surface, taking the actual blood flow into account, has not been done so far. Besides this, no one has even imagined that the actual conditions of normal blood flow near the skin surface would significantly affect correct massaging technique and the effects of massage treatment. Furthermore, no attempts at all have been made to closely examine the actual conditions of blood flow and to use information about the actual conditions for guiding and teaching of massage treatment.

[Patent Document 1] Japanese Unexamined Patent Publication No. 2000-119157

[Patent Document 2] Japanese Unexamined Patent Publication No. 2001-37542

[Patent Document 3] Japanese Unexamined Patent Publication No. H10-113370

[Patent Document 4] Japanese Unexamined Patent Publication No. H7-171184

[Non-Patent Document 1] Gray's Anatomy, 38th ed., Williams, P. L. et al., Churchill Livingstone

[Non-Patent Document 2] The Arterial Anatomy of Skin Flaps, Cormack, G. C. et al., Churchill Livingstone.

The present invention was made against the background of the aforesaid problems and its purpose is to provide illustrations that could be used as educational materials for teaching massage treatment and for teaching dermatological therapeutic techniques, dermatological diagnostic methods, etc., through anatomical elucidation of the veins, taking into account the actual conditions of blood flow at locations near the skin surface, and based on novel anatomical findings thus obtained. Other purposes of the invention are to provide means of reducing variation among individual massage givers in benefits of massage treatment, i.e., to provide methods of giving massage treatment and methods of teaching and explaining massage treatment, using such illustrations.

### DISCLOSURE OF THE INVENTION

To achieve the aforesaid objectives, the illustrations of the present invention include a first illustration, which displays anatomical characteristics of the skin, including the position and state of the cutaneous veins and valves within the veins. In this type of illustration, it is preferable for the first illustration to include vessels of the subdermal venous plexus formed immediately below the dermis by veins not accompanied by arteries, and thin blood vessels that ascend from this subdermal venous plexus towards the epidermis, as far as the cutaneous veins are concerned; and valves present at the basal parts of the thin blood vessels ascending from the subdermal venous plexus, as far as the valves are concerned. Also, it is preferable for the first illustration to include the vessels of the subdermal venous plexus formed immediately below the dermis by veins not accompanied by arteries, and the thin blood vessels that ascend from the subdermal venous plexus towards the epidermis, as far as the cutaneous veins are concerned; and valves present on the side closer to the skin surface (hereinafter referred to as “distal side”) of the branching points of the vessels of the subdermal venous plexus, as far as the valves are concerned. Moreover, it is preferable for the first illustration to include vessels of venous plexus formed in the deep dermis by veins not accompanied by arteries, and thin blood vessels that ascend from the aforesaid deep dermal venous plexus towards the epidermis, as far as the cutaneous veins are concerned; and valves present at the bases of the thin vessels ascending from the deep dermal venous plexus and on the distal side of the branching points of the vessels of the deep dermal venous plexus, as far as the valves are concerned.

Besides, it is preferable for the first illustration to include vessels of the deep dermal venous plexus and/or the subdermal venous plexus, formed in the deep dermis and/or immediately below the dermis, by the veins not accompanied by arteries, and

the cutaneous veins draining the venous plexus, which extend from the vessels of the deep dermal venous plexus and/or subdermal venous plexus and join up with the accompanied veins that run side by side with arteries, and/or with the unaccompanied veins of the deep subcutaneous fat layer,

as far as the cutaneous veins are concerned; and

include the valves on the distal side at the joining points of the cutaneous veins draining the venous plexus with the accompanied veins and/or on the distal side at the joining points of said draining cutaneous veins with the unaccompanied veins in the deep subcutaneous fat layer,

as far as the valves are concerned.

It is preferable that the aforesaid type of illustration includes a second illustration that gives an enlarged view of anatomical characteristics of the skin, including the position and state of the epidermis, dermis, veins in the region immediately below the dermis and the valves of these veins shown in the first illustration. Moreover, it is preferable for the second illustration to include

the vessels of the deep dermal venous plexus and/or the subdermal venous plexus formed in the deep dermis and/or immediately below the dermis, by the veins not accompanied by arteries,

thin vessels of the dermis layer that ascend towards the epidermis from the vessels of the deep dermal venous plexus and/or the aforesaid subdermal venous plexus,

the vessels of the subepidermal plexus of thin veins formed immediately below the epidermis branching out from the thin vessels of the dermis, and

thin vessels ascending from the vessels of subepidermal plexus of thin veins towards the epidermal papillae,

as far as the veins are concerned; and

include the valves present at the bases of the thin vessels of the dermis ascending from the deep dermal venous plexus and/or the subdermal venous plexus,

as far as the valves are concerned.

Besides this, it is preferable for the aforesaid type of illustration to include a third illustration depicting the position and state of the cutaneous veins and valves in these veins on an external view of the whole or a part of the human body. Also, it is better if the aforesaid type of illustration includes a 4th illustration wherein the position and state of lymph vessels are depicted on an external view of the whole or a part of the human body, a 5th illustration in which the position and state of muscles within the skin and/or in the subcutaneous tissue are depicted on an external view of the whole or a part of the human body, and also a 6th illustration depicting the positions of acupressure points on an external view of the whole or a part of the human body. The position and state of bones beneath the cutaneous tissue may be additionally displayed on any of the 3rd to 6th illustrations described above.

For achieving the aforesaid objectives, the method of teaching massage treatment of the present invention uses the aforesaid types of illustrations as teaching materials. In this method of teaching massage treatment, it is preferable that the massage treatment is for improving blood circulation in the skin that has become stagnant; preferable that the massage treatment includes a procedure (A) that consists of pressing the thin vessels ascending from deep dermal venous plexus and/or the subdermal venous plexus, which are formed in the deep dermal layer and/or immediately below the dermis, by veins unaccompanied by arteries, towards their respective plexuses; preferable that the massage treatment includes the procedure (B), which is sequential pressing of the deep dermal venous plexus and/or the subdermal venous plexus, towards the direction of the venous plexus draining cutaneous veins that gather blood from the deep dermal venous plexus and/or the subdermal venous plexus, after the procedure (A); and preferable that the massage treatment also includes a procedure (C) in which the venous plexus draining cutaneous veins are pressed towards the proximal side after the procedures (A) and (B). It is also preferable that the procedure (B) of the massage treatment is done with a pressure stronger than used in the procedure (A),

that the procedure (C) is done with a stronger pressure than the procedure (B), and

that a cream is applied by stroking on the skin surface of the part to be massaged, before or at the time of the procedure (A). Further, it is also preferable to include a procedure in which the lymph vessels and/or muscles present in the skin or beneath the cutaneous tissue in the part to be massaged are pressed or plucked. Moreover, it may include a procedure for stimulating the acupressure points located in the skin or below the cutaneous tissue of the part to be massaged.

To achieve the aforesaid objectives, the massage treatment method of the present invention aims at improving stagnant blood circulation in the skin, on the basis of anatomical characteristics of skin, including the position and state of the cutaneous veins and the valves in these veins, and the massage treatment method is characterized by having a procedure (A) of pressing the thin vessels—ascending from deep dermal venous plexus and/or the subdermal venous plexus, which are formed in the deep dermal layer or immediately below the dermis by veins unaccompanied by arteries—towards their respective plexuses. In this massage treatment method, it is preferable that a procedure (B)—which is sequential pressing of the deep dermal venous plexus and/or the subdermal venous plexus towards the direction of the venous plexus draining cutaneous veins, which gather blood from the deep dermal venous plexus and/or the subdermal venous plexus—is included after the procedure (A);

it is preferable that the massage treatment method includes a procedure (C) in which the venous plexus draining cutaneous veins are pressed towards the proximal side, after the procedures (A) and (B); and

it is further preferable that the procedure (B) of the massage treatment is done with a pressure stronger than used in the procedure (A) and that the procedure (C) is done with a stronger pressure than the procedure (B). A cream may be applied by stroking on the skin of the part to be massaged before or at the time of the procedure (A);

it is also preferable to include a procedure of pressing or plucking the lymph vessels and/or muscles present in the skin or beneath the cutaneous tissue in the part to be massaged; and

it is also preferable to include a procedure for stimulating the acupressure points located in the skin or below the cutaneous tissue of the part to be massaged.

Illustrations of the present invention contain displays of novel anatomical information about blood vessels, which clearly show the actual state of blood flow near the surface of the skin, i.e., they display the three-dimensional structure of cutaneous veins and the locations of the valves in the cutaneous veins and the position and state of valves in the veins, and therefore, persons to be trained in massage treatment, like masseurs and physicians, can be made to well understand new and effective methods of massage treatment, dermatological therapeutic techniques, dermatological diagnostic methods, etc. Also, by using, as teaching materials, the second illustration that displays an enlarged view of the anatomical characteristics of the skin, including the epidermis, dermis, the veins immediately below the dermis, and the position and state of the valves in the veins,

in combination with the first illustration that displays the venous plexus formed immediately below the dermis and/or in the skin by veins not accompanied by arteries, the thin vessels ascending from this venous plexus, and valves present at the bases of these thin vessels,

the persons to be trained in massage treatment are made to understand the actual position and state of the cutaneous veins and the valves in the veins and the actual state of blood flow in greater detail and with better clarity.

In the method of teaching massage treatment of the present invention, the aforesaid illustrations displaying the anatomical characteristics of the skin are used as teaching materials. No such illustrations were available anywhere in the world until now. By using such illustrations for explaining massage treatment, providers of massage treatment is made to understand the actual state of blood flow at locations near the skin surface and highly effective massage treatment is taught. Besides, this way of teaching massage treatment reduces variation in the technique among individual massage givers, because the fundamental points of the treatment are understood easily.

The method of massage treatment of the present invention is a new technique in which the procedure of pressing the thin vessels ascending from the venous plexus, formed immediately below the dermis, towards the venous plexus is first performed,

the procedure of sequentially pressing the venous plexus towards the veins that collect the blood from the subdermal venous plexus (cutaneous veins draining the venous plexus), which are unaccompanied by arteries, is then performed, and

finally the veins present in the deep subcutaneous layer, into which the venous plexus is drained, are pressed towards the proximal side. By adopting this method, excellent effect can be achieved, no matter who gives the massage.

### BRIEF DESCRIPTION OF THE DRAWINGS

FIG. 1 is an explanatory drawing showing an illustration of Embodiment 1.

FIG. 2 is an explanatory drawing showing an illustration of Embodiment 2.

FIG. 3 is an explanatory drawing showing an illustration (front view of face) of Embodiment 3.

FIG. 4 is an explanatory drawing showing an illustration (side view of face) of Embodiment 3.

FIG. 5 is an explanatory drawing showing an illustration (side view of face) of Embodiment 4.

FIG. 6 is an explanatory drawing showing an illustration (front view of face) of Embodiment 5.

FIG. 7 is an explanatory drawing showing an illustration (side view of face) of Embodiment 5.

FIG. 8 is an explanatory drawing showing an illustration (front view of face) of Embodiment 6.

FIG. 9 is an explanatory drawing showing an illustration (side view of face) of Embodiment 6.

FIG. 10 is an explanatory drawing showing an illustration (veins of the hand and forearm) of Embodiment 9.

FIG. 11 is an explanatory drawing showing an illustration (veins on the palm side of the hand and forearm) of Embodiment 9.

FIG. 12 is an explanatory drawing showing an illustration (veins on the back side of the hand and forearm) of Embodiment 9.

FIG. 13 is an explanatory drawing showing an illustration (muscles on the palm side of the hand and forearm) of Embodiment 9.

FIG. 14 is a drawing explaining a 1st step of the massage treatment method.

FIG. 15 is a drawing explaining a 2nd step of the massage treatment method.

FIG. 16 is a drawing explaining a 3rd step of the massage treatment method.

FIG. 17 is a drawing explaining a 4th step of the massage treatment method.

FIG. 18 is a drawing explaining a 5th step of the massage treatment method.

FIG. 19 is a drawing explaining a 6th step of the massage treatment method.

FIG. 20 is a drawing explaining a 7th step of the massage treatment method.

FIG. 21 is a drawing explaining an 8th step of the massage treatment method.

FIG. 22 is a drawing explaining a 9th step of the massage treatment method.

FIG. 23 is a drawing explaining a 10th step of the massage treatment method.

FIG. 24 is a drawing explaining an 11th step of the massage treatment method.

FIG. 25 is a drawing explaining a 12th step of the massage treatment method.

### PREFERRED EMBODIMENTS OF THE INVENTION

In the following part we will explain preferred embodiments of the illustrations, and the methods of teaching massage treatment and performing massage treatment that use the illustrations, referring to the drawings. We will explain here mainly about the massage treatment method and the method of teaching the massage treatment, which are the targets of using the illustrations of the present invention, but the illustrations may also be used as educational materials over a wider range, including teaching of dermatological therapeutic techniques and dermatological diagnostics.

### Embodiment 1

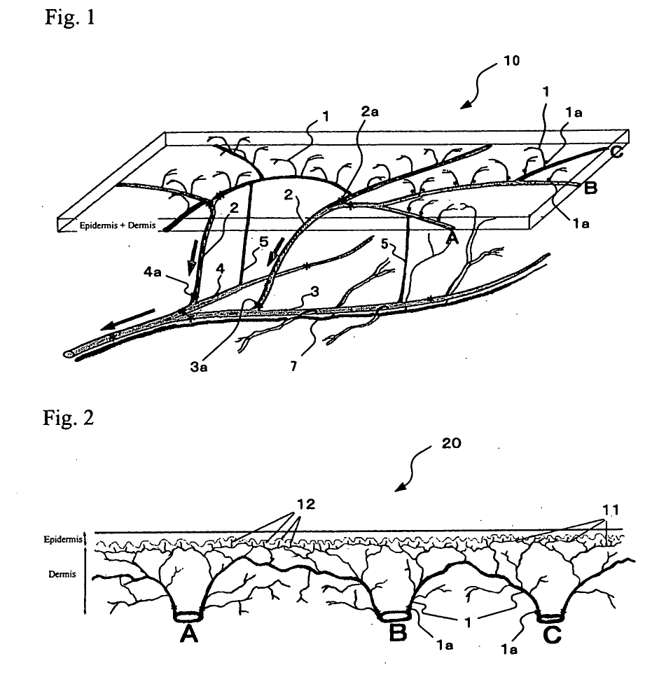

FIG. 1 is a first illustration 10 of Embodiment 1. It shows cutaneous veins in the part from the superficial part of the skin to the deep subcutaneous region, and valves in the veins. In this Embodiment 1, the first illustration 10 shows a vein (accompanied vein 3) accompanied by an artery 7 and a vein (unaccompanied vein 4) not accompanied by an artery. It also shows that most of the unaccompanied veins 4 form a venous plexus (the part including vessels A, B and C of FIG. 1) of comparatively large diameter veins, immediately below the dermis (or in the deep dermis). It also shows the presence of valves 1a (marked with asterisks in the Fig.)—which prevent reverse flow (in a distal direction) of blood from the region of the venous plexus immediately below the dermis (or in the deep dermis)—at the bases of thin vessels 1 ascending from the venous plexus located immediately below the dermis (or in the deep dermis) towards the superficial part of the skin.

On the other hand, it is shown that thick veins 2 that drain the aforesaid subdermal venous plexus (cutaneous veins draining the venous plexus) are present in the subcutaneous fat layer. These cutaneous veins 2 that drain the venous plexus descend through the subcutaneous fat layer diagonally to join the accompanied vein 3 or the thick unaccompanied vein 4 (which usually runs parallel to the skin surface over a relatively long distance) present independently in the deep subcutaneous fat layer. Moreover, there are vessels 5 that descend perpendicularly from different sections of the venous plexus (the part including the vessels A, B and C in FIG. 1) located immediately below the dermis. The vessels 5 merge with the unaccompanied vein 4 in the deep subcutaneous fat layer, the vein 3 accompanied by the artery 7 that supplies nutrients to the skin, or relatively thick accompanied veins below the fascia (not shown in the Fig.).

There are relatively thick communicating branches in some parts between the thick unaccompanied vein 4 located in the deep subcutaneous fat layer and the accompanied veins below in the fascia. Density and alignment of the subdermal venous plexus lying just below the dermis differ from one part of the body to another. Even the veins that drain the plexus and the thick cutaneous veins in the deep subcutaneous fat layer show characteristic structure and distribution (not shown in the Fig) in different parts of the body. Aside from the valves 1a present at the bases of the aforesaid thin vessels 1, there are many types of valves in the venous system, including the valves 2a (marked with an asterisk in the Fig.) on the distal side of the branching points of the vessels of the subdermal venous plexus, valve 3a (marked with an asterisk in the Fig.) on the distal side at the joining point of a cutaneous vein 2 draining the plexus with the accompanied vein, and valve 4a (marked with an asterisk in the Fig.) present on the distal side of the joining point of a cutaneous vein 2 with the unaccompanied vein 4 in the deep subcutaneous fat layer, all of which direct the blood flow. The arrows in FIG. 1 show the direction of blood flow.

From the aforesaid three-dimensional structure of the venous system, we can understand that the blood that supplies nutrients to the dermis first enters the thin vessels 1 ascending from the venous plexus and from there flows into the venous plexus, which lies immediately below the dermis (partly in the deep dermis), where the blood is pooled, moves to the accompanied vein 3 in the deep region via the vessels 2 that drain the plexus or via the vessels 5 that descend perpendicularly from some parts of the plexus—also via the unaccompanied vein 4 in the deep subcutaneous fat layer in some cases—and finally returns to the heart.

### Embodiment 2

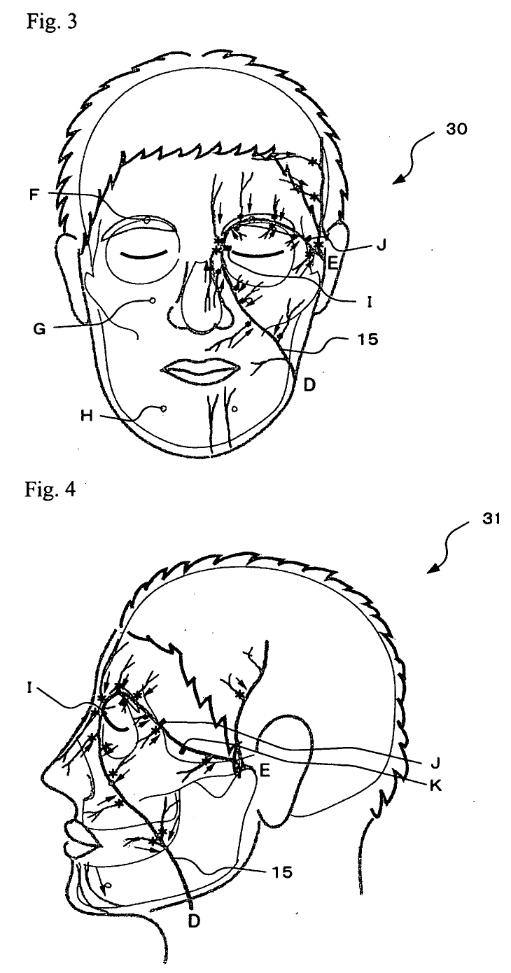

FIG. 2 shows the 2nd illustration, as a second embodiment of the invention, and is an enlarged view of the anatomical characteristics of the skin, including the position and state of the epidermis, dermis and veins in the region immediately below the dermis, and the valves in these veins shown in the illustration 10 of FIG. 1. In this Embodiment 2, an illustration 20 of FIG. 2 shows a number of thin vessels 1 ascending towards the epidermis from the vessels (A, B and C) of the venous plexus immediately below the dermis (or in the deep dermal layer), and branching and spreading immediately below the epidermis. It also shows that thinner vessels 11 arising from a number of these thin vessels 1 form a plexus immediately below the epidermis, and even thinner vessels 12 form a venous plexus towards the epidermal papillae. In other words, it shows that the unaccompanied veins, which do not run side-by-side with arteries, are immediately below the dermis (or in the deep dermal layer), the unaccompanied veins form a venous plexus immediately below the dermis (or in the deep dermis),

the thin vessels 1 (thin vessels of the dermal layer) ascend towards the epidermis from each vessel of this venous plexus, forming a subepidermal venular plexus immediately below the epidermis, and

that the even thinner vessels ascend from the vessels of this subepidermal venular plexus towards the epidermal papillae. Valves 1a are shown to be located at the bases of these thin vessels of the dermal layer ascending from the vessels of the subdermal venous plexus (or the deep dermal venous plexus).

### Embodiment 3

FIGS. 3 and 4 are of 3rd illustrations of Embodiment 3, which show the position and state of cutaneous veins and the valves in these veins, on an external view of a face, as an example of the whole or a part of the human body. This Embodiment 3 includes an illustration 30 (a front view of the face) and an illustration 31 (a side view of the face) as 3rd illustrations. These 3rd illustrations 30 and 31 are useful because they can be used, along with the 1st illustration 10 and the 2nd illustration 20, as a basis for explaining a method of massage treatment of the face.

The 3rd illustrations 30 and 31 will be explained below in greater detail.

The 3rd illustration 30 (a front view of the face) and the 3rd illustration 31 (a side view of the face) display a roughly U-shaped vein 15 running from a point D on the neck to a point E at the root of the earlobe, looping around the orbit. This vein 15 that is roughly in the shape of an inverted U (referred to as “roughly U-shaped vein” hereinafter) basically runs at a depth deeper than the muscles of facial expression (which will be discussed later), joins at its one end D with the large vein of the neck, and runs deeper and descends from its other end E near the ear and similarly joins the large vein of the neck. Aside from these, comparatively thick veins emerge from the roughly U-shaped vein 15 towards the deeper region at three points, namely, at the medial angle of the eye (I), one fingerbreadth from the lateral end of the eyebrow (J), and at about the middle of a line connecting the lateral angle of the eye and the base of the earlobe (K).

Incidentally, in the face, the veins present at a shallower depth than the lower border of the dermis consist of the subdermal venous plexus and the thin veins ascending from this venous plexus (see FIGS. 1 and 2). Moreover, the aforesaid subdermal venous plexus and the roughly U-shaped vein 15 are connected via blood vessels that drain the veins of the plexus, i.e., the cutaneous veins draining the venous plexus. Moreover, the veins have valves that regulate the direction of blood flow. In other words, valves are present at places where the thin veins ascend from the venous plexus, where the veins that drain the venous plexus join with the roughly U-shaped vein 15 (marked with asterisks in the Figs.), and inside the roughly U-shaped vein 15 the direction of blood flow in the veins (indicated by arrows in the Figs.) is determined by the direction of these valves. Thus, the massage giver is made to understand well the actual condition of blood flow at different locations on the facial skin.

The 3rd illustrations 30 and 31 display three holes on each side on the skull through which the cranial nerves come out. These are the supraorbital foramen F through which the supraorbital nerve, the sensory nerve of the forehead, comes out, the infraorbital foramen G through which the infraorbital nerve comes out, and the mental foramen H, located at the mental region of the mandibular bone, through which the mental nerve comes out. These three nerves (the supraorbital, infraorbital and mental) are originally branched from the trigeminal nerve (the ophthalmic, the maxillary and the mandibular), and these three nerves govern the senses approximately of the upper third, middle third and lower third, respectively, of the face. The third illustrations 30 and 31 also show the position and state of the bones beneath the cutaneous tissue, within the display of the external appearance of the face. This helps to verify the positional relationships between the bones and the position and state of the cutaneous veins and valves, and is therefore beneficial for more effective teaching of massage treatment.

### Embodiment 4

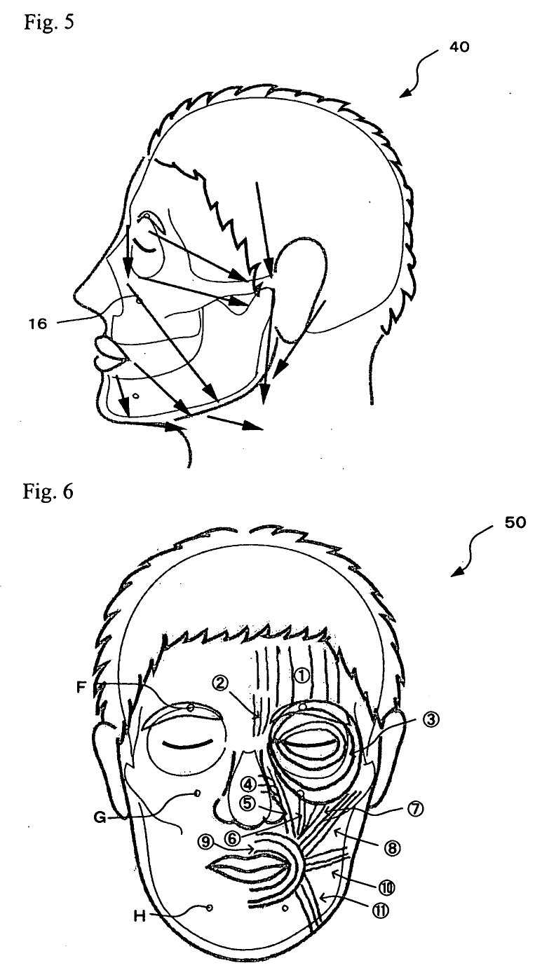

FIG. 5 is a 4th illustration 40 (side view of a face) of Embodiment 4, which displays the position and state of lymph vessels and the flow of lymphatic fluid within a display of the external appearance of the face, as an example of the whole or a part of the human body. In this Embodiment 4the 4th illustration 40 displays the position of the lymph vessels and the flow of lymphatic fluid in terms of approximately drawn arrows 16. It is understood that basically the flow of lymphatic fluid is also promoted when the skin is massaged along the direction of flow in the veins. Thus, the 4th illustration 40 is useful as a supplementary illustration for explaining the method of giving facial massage, when used along with the first illustration 10 and the 2nd illustration 20.

### Embodiment 5

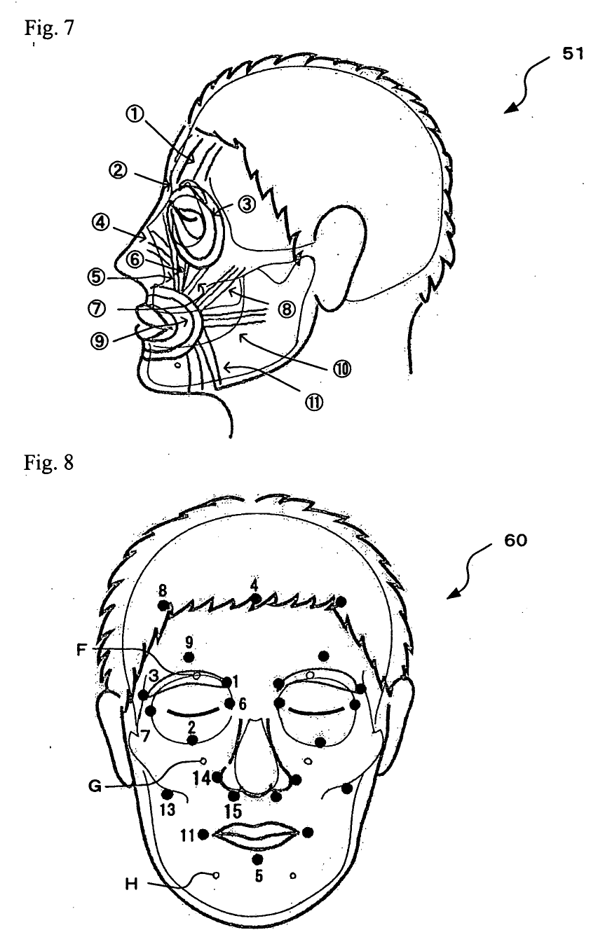

FIGS. 6 and 7 are 5th illustrations of Embodiment 5, which display the position and state of muscles in the skin and/or beneath the cutaneous tissue, which in this case are within the subcutaneous tissue, in a view of the external appearance of the face, as an example of the whole or a part of the human body. In this Embodiment 5 the 5th illustration includes an illustration 50 (a front view of the face) and an illustration 51 (a side view of the face). The 5th illustrations 50 and 51 show the muscles of expression of the face and therefore are not only useful in making the massage givers understand, at the time of massaging the face, the directions of the fibers of the muscles of facial expression and the actions of the muscles, but also useful in teaching more efficient massage treatment because the positional relationships between these muscles and veins are verified. The muscles of facial expression in different parts of the face and their actions are shown in Table 1.

TABLE 1

| | Muscle of expression | Action |
|---|---|---|
| 1 | Venter frontalis muscle | Raising eyebrows and forming transverse wrinkles on |
| | | forehead |
| 2 | Procerus muscle | Creating transverse wrinkles on the skin of the root of |
| | | the nose |
| 3 | Orbicular muscle of the eye | Closing the optic fissure |
| 4 | Nasal muscle | Lowering of the nose tip and narrowing of the nostril |
| 5 | Elevator muscle of upper lip | Raising of the upper lip and the nose wings |
| | and wing of nose | |
| 6 | Elevator muscle of upper lip | Raising of the upper lip |
| 7 | Lesser zygomatic muscle | Raising of the upper lip |
| 8 | Greater zygomatic muscle | Moving the corners of the mouth upward and outward |
| 9 | Orbicular muscle of the mouth | Closing the oral fissure and pouting |
| 10 | Laughing muscle | Pulling the corners of the mouth outwards and creating |
| | | dimples |
| 11 | Depressor muscle of angle of | Pulling down the corners of the mouth when both |
| | mouth | sides of the muscle contract, or pulling the corner of |
| | | the mouth on the side where the muscle contracts |
| | | when one side of the muscle contracts |

The basic structure of the face, starting form the inside, consists of the bones, the ter muscles, fat tissue (fatty fascia) including the muscles of facial expression, and the The “fat tissue including the muscles of facial expression” means that the muscles of expression basically exist sandwiched between layers of fat tissue. Under this condition, the fat tissue layer below the muscles of facial expression has a structure that can easily slip and move whereas the fatty layer above the muscles of facial expression is firmly attached to the dermis. We can see that because of this structure, the muscles of facial expression themselves can move easily, independently of the bone structure beneath them, and the movement of these muscles is faithfully reflected on the skin.

### Embodiment 6

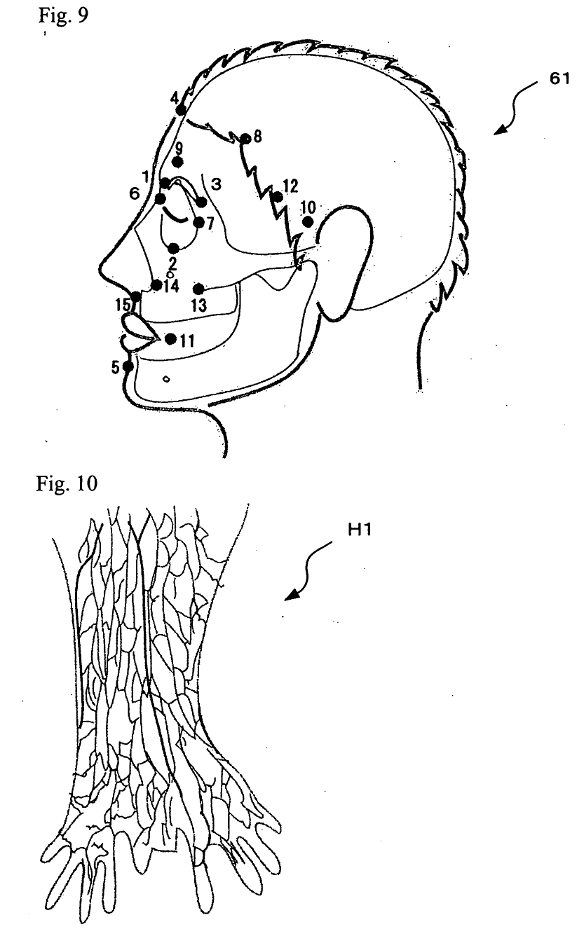

FIGS. 8 and 9 are 6th illustrations of the Embodiment 6 and they show the position of acupressure points on external views of the face, as a representative of the whole or a part of the human body. This Embodiment 6, includes an Illustration 60 (front view of a face) and an Illustration 61 (side view of a face), as 6th illustrations. The major acupressure points present on the face, the related nerves and muscles and their actions are listed in Table 2, corresponding to the 6th illustrations 60 and 61.

TABLE 2

| | | | Sensory | |
|---|---|---|---|---|
| | Acupressure point | Location | nerve | Related muscle |
| 1 | Zanzhu (Bladder | Medial end of eyebrow | Ophthalmic | Orbicular muscle of |
| | Meridian) | | nerve | eye |
| 2 | Sibai (Stomach | One fingerbreadth below the | Maxillary | Orbicular muscle of |
| | Meridian) | pupil | nerve | eye |
| 3 | Sizhukong (Triple | Lateral end of eyebrow | Maxillary | Orbicular muscle of |
| | Energizer Meridian) | | nerve | eye |
| 4 | Shenting (Governor | Half fingerbreadth above the | Supraorbital | Venter frontalis |
| | Vessel Meridian) | front hairline at the median | nerve | muscle |
| | | line of the forehead | | |
| 5 | Chengjiang | Center of the groove between | Mandibular | Orbicular muscle of |
| | (Conception Vessel | the lower lip and chin | nerve | mouth |
| | Meridian) | | | |
| 6 | Jingming (Bladder | Near the medial angle of the | Ophthalmic | Medial palpebral |
| | Meridian) | eye | nerve | ligament, |
| | | | | orbicular muscle of |
| | | | | eye |
| 7 | Tongziliao (Gall | Near the lateral angle of the | Maxillary | Orbicular muscle of |
| | bladder Meridian) | eye | nerve | eye |
| 8 | Touwei (Stomach | Half fingerbreadth from | Ophthalmic | Venter frontalis |
| | Meridian) | corner of the brow | nerve | muscle |
| 9 | Yangbai (Gall | One fingerbreadth above the | Supraorbital | Venter frontalis |
| | bladder Meridian) | center of the eyebrow | nerve | muscle |
| 10 | Qubin (Gall bladder | The midpoint between the ear | Auriculo- | Temporal muscle |
| | Meridian) | apex and the origin of the | temporal | |
| | | helix | nerve | |
| 11 | Dicang (Stomach | Near the corner of the mouth | Maxillary | Orbicular muscle of |
| | Meridian) | | nerve | mouth |
| 12 | Xuanlu (Gall | One fingerbreadth below the | Auriculo- | Temporal muscle |
| | bladder Meridian) | temple | temporal | |
| | | | nerve | |
| 13 | Quanliao (Small | Immediately below the | Maxillary | Greater zygomatic |
| | Intestine Meridian) | zygomatic process | nerve | muscle |
| 14 | Yingxiang (Large | Outer edge of the nose wing | Maxillary | Elevator muscle of |
| | Intestine Meridian) | | nerve | upper lip and wing |
| | | | | of nose, |
| | | | | elevator muscle of |
| | | | | upper lip |
| 15 | Heliao (Large | Alar part of the nasalis | Maxillary | Orbicular muscle of |
| | Intestine Meridian) | muscle just below the nostril | nerve | mouth |

The parent nerve that governs the senses of the facial skin is the trigeminal nerve housed in the cranium. Though the roots of such cutaneous nerves do not always exist near acupressure points, acupressure points are closely linked with the sensory nerves of facial skin. It is therefore important to know the locations of these acupressure points in massage treatment. The 6th illustrations 60 and 61 are useful as supplementary illustrations, when used along with the 1st illustration 10 and the 2nd illustration 20, in teaching and explaining the method of the massage treatment, and are expected to bring about synergetic effects for the effect of the massage treatment arising from the improved blood flow at different parts of the facial skin.

The illustrations of the present invention as detailed above may be in the form of displays on sheets, boards, booklets, film, screens, CRTs, liquid crystal displays, (transparent) models or combinations of these media, or in any other form of displays. A method of display is not specified here; printing, projection, display on computers, etc. may be employed. These illustrations should preferably convey three-dimensional images. Especially, the position of the valves in the vascular system provides very important information for making massage givers to understand the type of treatment that is best suited for returning the stagnant blood to a central part of the circulatory system, such as the heart.

Besides this, in the illustrations of the present invention, a key role is played by clear depiction of the location of the valves. Therefore, it is preferable to use a conspicuous color, different from that of other parts to highlight the valves. Red is an example of a suitable conspicuous color. Besides, it is preferable to use different colors for the arteries and veins in the illustrations of the present invention because of the directionality of blood flow in them. In the color-coding of arteries and veins, it is conventional to use red for arteries and blue for veins. So, it is preferable to follow this convention. Aside from this, it is important that the thin blood vessels ascending from the venous plexus on which the valves are present should be massaged first. So, it is important to depict these thin blood vessels in a color different from that of the venous plexus. For instance, a blue color that is different in intensity, chroma or shade from that used for the venous plexus may be used, for this purpose.

### Embodiment 7

Embodiment 7 is a method of teaching massage treatment wherein the illustrations described in the aforesaid Embodiments 1 to 6 are used as teaching materials. When such illustrations are used as massage treatment teaching materials, massage givers can understand the procedures quickly, and it becomes possible for them to learn the technique quickly and acquire deep knowledge about it. The major point here is to make them understand that the massage treatment is a technique for improving the circulation of blood that is stagnating in the skin. This embodiment is also intended to make the massage givers understand that this is a procedure (A) to press the thin vessels ascending from the deep dermal venous plexus and/or the subdermal venous plexus towards their respective venous plexuses. The venous plexuses are formed in the deep dermal region or and/or immediately below the dermis by veins unaccompanied by arteries.

This embodiment is also for making the massage givers understand that the massage treatment has a procedure (B), performed after the aforesaid procedure (A). The procedure (B) is sequential pressing of the deep dermal venous plexus and/or the subdermal venous plexus, towards the direction of the cutaneous veins draining the venous plexus, which gather the blood from the deep dermal venous plexus and/or the subdermal venous plexus. Here, they are also made to understand that a procedure (C), in which the cutaneous veins draining the venous plexus are pressed towards the proximal side, is also carried out after the procedures (A) and (B) and that the procedure (B) is done with a pressure stronger than used for the procedure (A) and the procedure (C) is done with a stronger pressure than the procedure (B). Moreover, they are also made to understand that the massage treatment is more effective when a cream is applied by stroking on the skin surface of the part to be massaged, before or at the time of the procedure (A),

a procedure in which the lymph vessels and/or muscles present in the skin or beneath the cutaneous tissue in the part to be massaged are pressed or plucked is done, and a procedure for stimulating the acupressure points located in the skin or below the cutaneous tissue of the part to be massaged is done.

The method of teaching massage treatment in this embodiment uses the illustrations of the present invention as teaching materials. The information that is taught may be applied not only for massage treatment but also for dermatological therapeutic techniques, dermatological diagnostics, etc.

### Embodiment 8

Embodiment 8 is a method of giving massage treatment that uses the illustrations described in the aforesaid Embodiments 1 to 6 the massage treatment method of this embodiment is based on anatomical characteristics of the skin, including the position and state of the veins in the skin and the valves in theses veins, and is primarily for improving the circulation of blood that is stagnating in the skin. This massage treatment method includes a procedure (A) to press, towards their respective venous plexuses, the thin vessels ascending from the deep dermal venous plexus and/or the subdermal venous plexus formed in the deep dermis and/or immediately below the dermis by veins not accompanied by arteries. It also includes a procedure (B), which is sequential pressing, after the procedure (A), of the deep dermal venous plexus and/or the subdermal venous plexus towards the direction of the cutaneous veins draining the venous plexus, which gather the blood from the deep dermal venous plexus and/or the subdermal venous plexus, and

the procedure (C) in which the cutaneous veins draining the venous plexus are pressed towards the proximal side, after the procedures (A) and (B). In this massage treatment method, it is effective

to carry out the procedure (B) with a pressure stronger than used in the procedure (A) and carry out the procedure (C) with a stronger pressure than of the procedure (B);

to apply a cream by stroking on the skin surface of the part to be massaged, before or at the time of the procedure (A);

to include a procedure of pressing or plucking the lymph vessels and/or muscles present in the skin or beneath the cutaneous tissue in the part to be massaged; and

to include a procedure of stimulating the acupressure points located in the skin or below the cutaneous tissue of the part to be massaged.

It may be mentioned here that at the time of giving the massage treatment, one has to try to facilitate effective return of the venous blood to the heart. Key points for achieving this are described below: (1) Effectively gather, in the venous plexus immediately below the dermis, the blood that has supplied its nutrients to the dermis. (2) Effectively force this blood, now pooled in the venous plexus, proximally (towards the heart) through the vessels that drain the venous plexus. (3) If there is a cutaneous vein in the deep subcutaneous fat layer, force the blood in that vein also effectively in the proximal direction. (4) Take the directionality of the valves into account.

Here, regarding (1), a number of thin vessels 1 (see FIGS. 1 and 2) ascend from the venous plexus (the veins (A), (B) and (C) in FIGS. 1 and 2), and therefore, by gradually applying pressure perpendicularly on the skin, the pressure being directed towards the deeper region, the blood is pushed towards the venous plexus. The blood will not flow back into the dermis because of the valves and it will get pooled in the venous plexus.

As for (2), the venous plexus is pressed sequentially towards the veins (vessels 2 of FIG. 1) that drain the plexus, with a stronger force, because the venous plexus is located immediately below the dermis or in the deep dermal layer, so that draining veins that are extensions of the venous plexus are pressed one after the other. Also, by applying an even stronger compressive force, the blood can be driven into the vessels (vessels 5 of FIG. 1) perpendicularly descending from branches of the venous plexus.

For (3), because the unaccompanied vein (vessel 4 in FIG. 1) of the subcutaneous fat layer is located deep down in the subcutaneous fat layer, it is pressed by applying a stronger force towards the proximal side. By doing this, the blood is driven towards the direction of the heart through this vessel and at the same time it is pushed out of the cutaneous vein into the communicating branches between the cutaneous vein and the deep-seated accompanied vein.

As for (4), the directionality of the valves, particularly those in the venous plexus, and in the thick cutaneous veins in the deep subcutaneous fat layer, is important. Conventionally, only the direction of the shortest distance to the heart, as perceived from the skin surface, was considered. Therefore, when this concept was applied, for example, when starting from the back, it was not clear whether “towards the direction of the heart” meant over the shoulder or via the underarm. However, in this embodiment, “towards the direction of the heart” does not mean the shortest distance to the heart but the direction of the venous blood flow towards the heart. In other words, the system of veins in skin is viewed in its three-dimensional structure rather than the two-dimensional structure. Moreover, the three-dimensional structure of cutaneous veins has characteristics that differ from one part of the body to another. Therefore, the suitable massage treatment differs, depending on the configuration and area of skin of the concerned part. Thus, massage procedure should be changed suitably according to the area to be treated.

### Embodiment 9

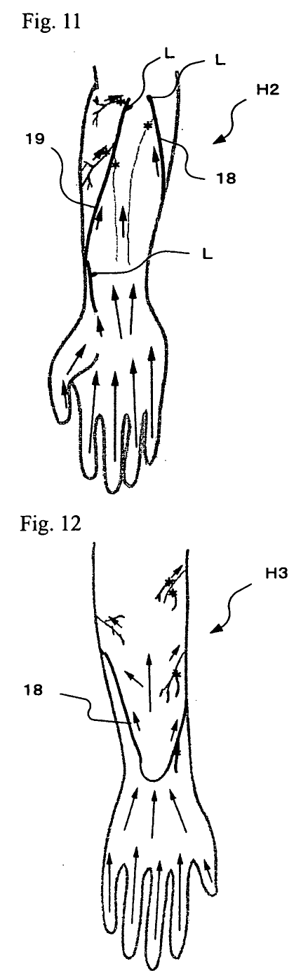

Embodiment 9 relates to the hand and the forearm. Illustrations related to the hand and forearm, and methods of teaching massage treatment and performing massage with the help of these illustrations will be explained below. FIGS. 10, 11 and 12 are illustrations H1, H2 and H3 of the Embodiment 9 the Illustration H1 shows some of the cutaneous veins of the hand and forearm, i.e., the veins located in the comparatively superficial regions. These veins are in the same category as the unaccompanied veins marked A, B and C in FIG. 1 and form a venous plexus of comparatively thick blood vessels immediately below the dermis. Therefore, the three-dimensional structure of this venous plexus is basically the same as in the 1st and 2nd illustrations of the Embodiments 1 and 2. Because of this, it is preferable to first teach the massage treatment using the 1 st and 2nd illustrations as teaching materials.

The venous plexus immediately below the dermis is anastomosed with the thick cutaneous veins (a basilic vein 18 and a radial vein 19), which run over a long distance in deep subcutaneous fat tissue and therefore, the venous plexus is drained into these thick cutaneous veins. It is almost the same as in the 3rd illustration of Embodiment 3, the thick cutaneous vein running over a long distance in the deep subcutaneous fat tissue corresponding to the roughly U-shaped vein of the face. The roughly U-shaped vein (loop) formed by the aforesaid basilic vein 18 and radial vein 19 is clearly shown on the dorsal side of the hand in the illustration H3 of FIG. 12 the illustration H2 of FIG. 11 shows the palm side of the hand. Both the basilic vein 18 and the radial vein 19 anastomose with the deeper vein (marked with Ls in the Fig.), mainly near the bend of the elbow (cubital fossa). Aside from this, branches (marked with Ls in the Fig.) descend from these venous plexuses here and there and anastomose with veins in the deeper region. The venous plexus of the hand on the palm side has a different morphology from that on the dorsal side, but they are connected with the venous plexuses on the respective sides of the forearm.

Valves (marked with asterisks in the Figs.) exist also in the veins of the hand and forearm. These valves are more developed than the ones on the face. They open towards the general direction (shown with arrows in the Figs.) of the shoulder. The veins have a three-dimensional structure even in the thin skin and subcutaneous layer of the forearm. The valves are also present at the points where the superficial veins anastomose with deep veins but the valves do not always open towards the shoulder when the forearm is viewed two-dimensionally. The basic route of the blood returning through the veins of the hand and forearm is as shown in FIGS. 11 and 12, as judged from the directions of the veins that drain the venous plexuses, and the thick veins of the subcutaneous fat layer, as well as the directionality of their valves.

FIG. 13 shows an illustration H4 that concerns muscles of the hand and forearm. It is better to have a deeper understanding with the help of an illustration like the illustration H4 at the time of giving massage treatment. In other words, FIG. 13 shows that the main part of the muscle (muscle N) that bends or straightens a finger is located in the forearm and that its distal end becomes the tendon M, which is attached to the bones of the finger. Moreover, the attachment of the tendons M to the finger, on both the palm side and the dorsal side of the hand, is to the proximal ends of the middle and distal phalanges. The tendon that bends the finger is on the palm side and the tendon that straightens the finger is on the dorsal side of the hand. Although not shown in the Fig., the forearm and hand also have lymph vessels and acupressure points in the cutaneous and subcutaneous tissue, and it is preferable to have deep knowledge about their locations. For example, it is beneficial to know at the time of the massage treatment that the lymphatic fluid flows in the direction of the shoulder. Therefore, the lymphatic flow can be enhanced by massaging basically along the direction of flow in the veins.

### Practical Embodiments

The illustrations of the present invention, and the methods of teaching massage treatment and giving massage treatment using the illustrations as teaching materials are explained below in concrete terms citing an example and an experimental example. However, these examples do not imply any restrictions as to the present invention.

### EXAMPLE 1

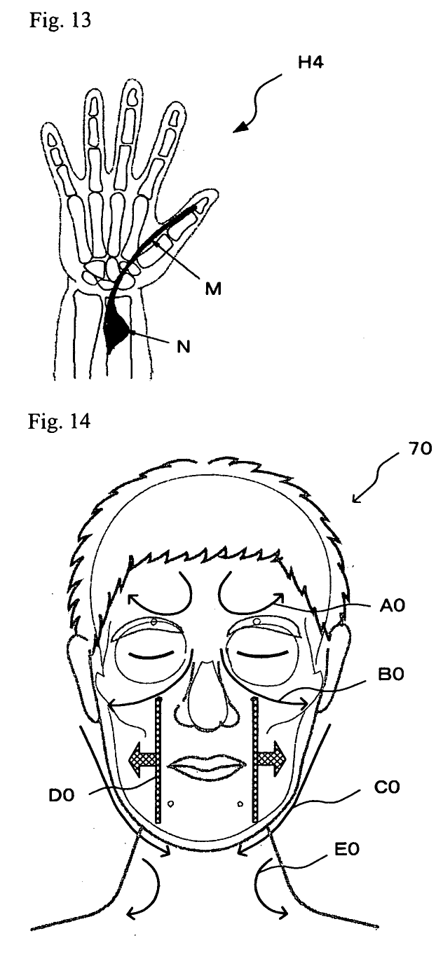

Example 1 is an example of a method of massage treatment that utilizes illustrations conforming to the 1 st to 6th illustrations of Embodiments 1 to 6 of the present invention. For teaching the massage treatment method of the present invention, firstly, the method is explained using the 1st and 2nd illustrations shown in FIGS. 1 and 2, on the basis of Embodiments 1 and 2 of the invention, and then the massaging treatment method described below is taught. FIG. 14 shows a first step 70 of the massage treatment in which a cream is applied. In this cream application step, a cream is applied three times by gently stroking the parts in the sequence A0, B0, C0, D0, and E0 shown in the Fig., in the directions indicated by these arrows. The main purpose of this step is to apply cream uniformly all over the face. Another purpose is to drive, simultaneously with the cream application, the venous blood within the dermis generally towards the looped veins (the roughly U-shaped veins shown in FIGS. 3 and 4) and also the venous blood, once it is in these looped veins, towards the extremities (indicated by D and E in FIGS. 3 and 4). Because the purpose is to force all of the venous blood in the face, the cream application should be done in the aforesaid sequence, starting from the forehead, which is farthest from the heart.

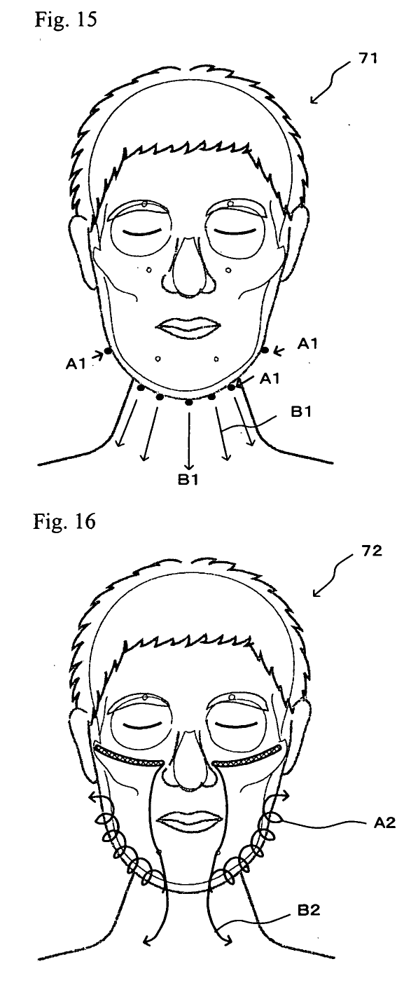

FIG. 15 shows a second step 71 of this massage treatment. This is a step in which the venous blood driven into the neck region from the looped veins is further pushed towards the heart.

For the above purpose, firstly, as shown in FIG. 15 the parts below the lower jaw are pressed once simultaneously on the left and right sides with the insides of three fingers of each hand from the chin towards the angle of the lower jaw (indicated as A1 in the Fig.). The neck is then lightly stroked from top down all over in two rounds (shown as B1 in the Fig.). This drives the venous blood at the boundary between the face and neck gradually from the chin to the proximal side. In short, this is a massaging method that returns the venous blood that has entered the neck portion to the heart. This step also has additional significance as a massage of the platysma muscle, which is one of the muscles of facial expression.

FIG. 16 shows a 3rd step 72 of this massage treatment. This is a step in which the masseter muscles are massaged and the facial veins are squeezed out. The masseter muscles are massaged as marked by A2 in the Fig., by gently stroking with the fists, moving in large circles all over the cheek, starting from the tip of the chin, which not only massages the masseter muscles but gives a massaging effect to other muscles of expression. Also, as indicated by B2 in the Fig., the massaging hands are moved from the front of the ears, passing below the zygomatic processes and then downward while applying pressure slightly outside the nasolabial groove and then turned diagonally outwards. This massage cleanses the central blood vessel that supplies nutrients to the facial skin because the blood collects at the extremity D (see FIGS. 3 and 4) of the looped vein on the face and the extremity D gets squeezed.

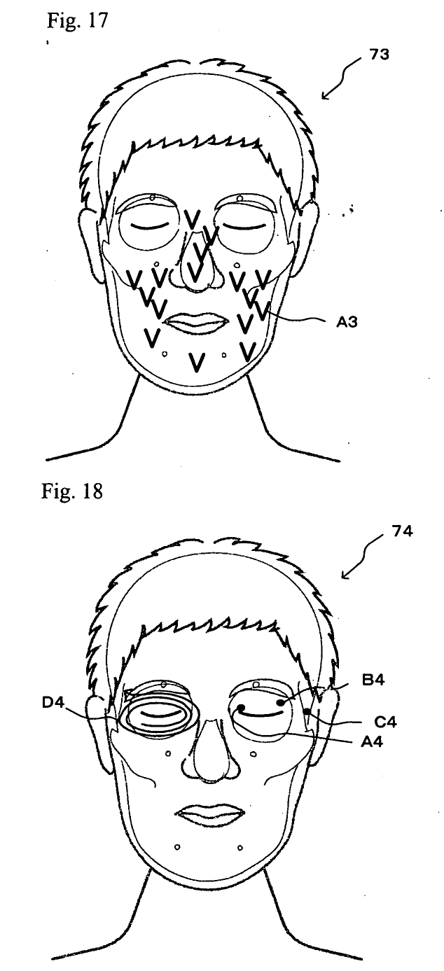

FIG. 17 shows a 4th step 73 of the massage treatment method. In this step, the skin, muscles of expression and the fat below the eyes are massaged. Here, the cheek, nose and upper and lower jaws (indicated by Vs labeled as A3 in the Fig.) are subjected to Pincement de Jacquet (Jacquet Pinching) massaging by plucking the skin, muscles of expression and fat for about 15-20 seconds. Deep-seated tissues can be massaged by plucking larger areas.

FIG. 18 shows a 5th step 74 of the massage treatment. This is a step where the areas around the eyes are massaged. In this step, firstly, three points, i.e., A4 at the medial angle of the eye, B4 at the lateral end of the eyebrow, C4 on the temple, are pressed with fingers twice simultaneously on the left and right sides. Then, the upper and lower eyelids are stroked gently, starting from their central part and gradually moving along larger and larger circles (shown as D4 in the Fig.), and finally escaping towards the pinna of the ear through the extremity E, i.e., the end of the loop (roughly U-shaped vein) (see FIGS. 3 and 4) located near the eyebrow. This operation is done once on the left side and once on the right side.

In the early part of Step 5 the acupressure points, such as Jingming (Bladder Meridian), Yangbai (Gall bladder Meridian), Tongziliao (Gall bladder Meridian) and Sizhukong (Triple Energizer Meridian), are stimulated and in the later part the venous blood of the upper and lower eyelids is gradually pushed into the looped vein (roughly U-shaped vein) by stroking along gradually expanding circles, finally squeezing the looped vein in the proximal direction, towards E, one of its extremities. This treatment also gives a massaging effect to the orbicular muscles and the eyelid levator muscle.

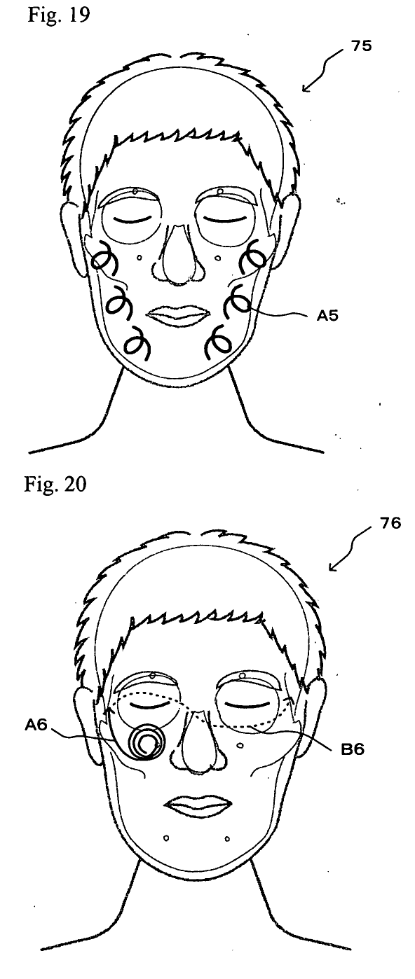

FIG. 19 shows a 6th step 75 of the massage treatment. In this 6th step, the whole palm of each massaging hand is moved from the chin to all over the cheek once (A5 in the Fig.). In other words, the venous blood accumulated in the superficial layer of the dermis is once collected in the venous plexuses immediately below the dermis and further pushed from the superficial layer to the deeper layer for forcing it to flow proximally (towards the heart).

FIG. 20 shows a 7th step 76 of this massage treatment. This 7th step relates to a massaging method that forces out the blood from the veins of the cheek. In this step, each cheek is lightly stroked starting at its center, moving in gradually expanding circles (A6 in the Fig.) towards the front of the ear, and then, crossing the temple, the finger is moved over to the other side along a figure 8-like path (B6 in the Fig.). This operation is done three times. By moving along gradually expanding circles, the blood accumulated in the venous plexus immediately below the dermis in the cheek is pushed towards one extremity of the roughly U-shaped vein (loop).

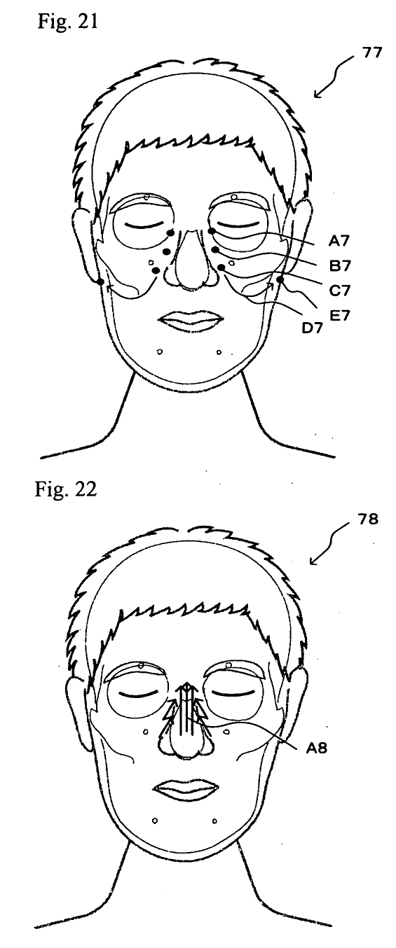

FIG. 21 shows an 8th step 77 of the massage treatment. In this step, the acupressure points around the nose and mouth are stimulated. Here, the three points on each side of the nose are pressed with a finger, starting from the uppermost one (in the sequence A7, B7 and C7). After that, the finger is moved below the zygomatic process following the contour as shown by D7 in the Fig. and then diagonally outward to below the ear. Then, the point E7 in the area of the parotid gland below the ear is pressed. This operation is done twice. This not only stimulates the acupuncture points, but the blood in one extremity of the looped vein is also squeezed out.

FIG. 22 shows a 9th step 78 of the massage treatment. In this Step 9 the massaging forces the blood in the veins in the nose area to flow. Firstly, the ridge of the nose is stroked upward. Then both the sides of the nose are also stroked similarly. This operation is for forcing the venous blood in the dermis of the nose into the looped vein and is performed once.

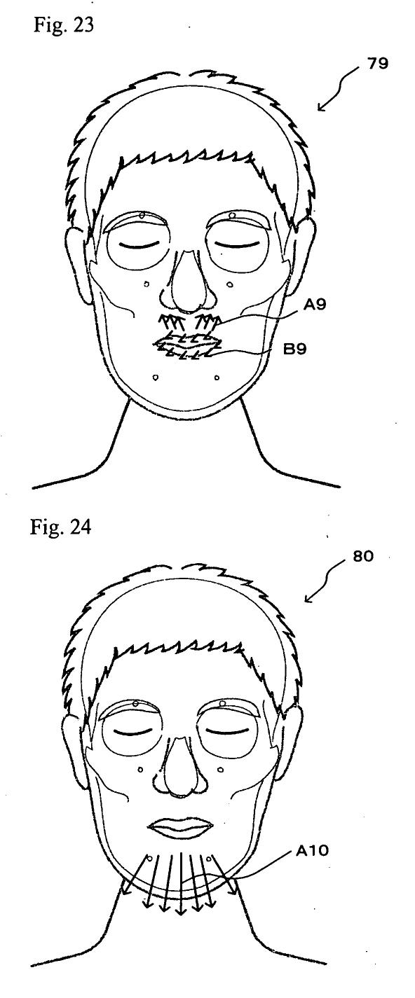

FIG. 23 shows a 10th step 79 of the massage treatment method. In this Step 10 the veins of the lip area and the orbicular muscle of the mouth are massaged by pushing up the region around the upper lip beyond the nasolabial groove, at close intervals (A9 in the Fig.). The whole of the lips are then subjected to Pincement (pinching) (as indicated by B9 in the Fig.). This operation forces the venous blood of the upper lip into the loops beyond the nasolabial groove and the orbicular muscle of the mouth gets massaged.

FIG. 24 shows an 11th step 80 of the massage treatment. This Step 11 relates to massaging that forces the venous blood from the lower lip region and the chin. The entire lower jaw is stroked downward with the insides of the thumbs (shown as A10 in the Fig.) and the operation is repeated once (stroked twice). This operation forces the venous blood in the lower lip and the chin towards the neck.

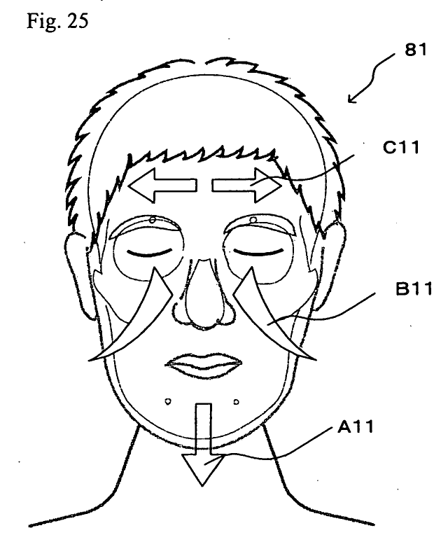

FIG. 25 shows a 12th step 81 of the massage treatment. In Step 12 the venous blood in the superficial layer of the dermis of the whole face is finally forced to flow into the venous plexuses immediately below the dermis by vertically stroking three times from the chin to the neck (shown as A11 in the Fig.), using three fingers. Next, both the cheeks are simultaneously stroked outwards three times while pressing down (shown as B11 in the Fig.). Finally, the whole of the forehead is stroked three times while applying pressure, from the middle (as shown by C11 in the Fig.). This operation forces the venous blood accumulated in the superficial to the deeper layers of the dermis finally into the loop where it is allowed to become sedate (calm down).

In the above-described method of massage treatment, the massage giver, having appropriate knowledge about the location of the valves in the thin vessels, applies suitable pressure in a direction to open them so that the blood is pushed sequentially towards the heart. By performing these procedures properly, the stagnant blood can be returned to the circulatory system and the peripheral blood flow and the oxygen content of the blood can be improved. This means, in other words, that massaging without proper knowledge will not bring about the aforesaid effect. Until now, the effectiveness of massage treatments differed greatly, depending on the massage giver, the reason for which is believed to be whether the massage giver had this type of knowledge or not.

In short, if the massage giver is suitably encouraged to acquire this type of knowledge and awareness, then irrespective of who the massage giver is, he or she will be able to provide massage that brings about distinct effects like “reduction in swelling,” “reduction of dullness,” etc. The valves present at the bases of the thin vessels ascending from the venous plexus immediately below the dermis and at the bases of the vessels that drain the venous plexus, and the state of the anastomoses between the vessels that drain the venous plexus and the cutaneous veins in the deep subcutaneous layer are particularly important aspects. It is thus important to take into account the location of the valves and the direction in which the veins run. Blood does not move easily unless pressure is applied along the direction in which the valves open. If pressure application and stroking is done along the direction of blood flow as conventionally perceived in the field of massage treatment, i.e., along a direction on the surface of the skin of the face, the reverse flow prevention mechanism of the valves is activated in many places and the treatment ends up only momentarily increasing the pressure in the blood vessels. Only when the pressure is applied towards the internal part of the skin, in a direction perpendicular to the skin surface, do the valves in the superficial layer of the skin open and allow the blood in this part of the skin to flow into the subdermal venous plexuses just below the dermis. Adjacent subdermal venous plexuses are weakly anastomosed in the dermis and therefore, the blood does not flow effectively to the adjacent plexuses by pressing sideways. In the next step, by applying pressure sequentially along the direction of the anastomoses of the vessels draining the subcutaneous venous plexus with the cutaneous veins in the deep subcutaneous region, the valves at the bases of these draining vessels can be opened and venous blood effectively forced into the deeper region.

The effects of the massage treatment include improving the blood flow in the veins close to the skin surface and increasing the oxygen partial pressure in that part. Such effects can be monitored by measuring the oxygen partial pressure in the hemoglobin in a noninvasive manner using spectral techniques.

Such monitoring will be explained in detail below, citing an experimental example.

### EXPERIMENTAL EXAMPLE

A 1st illustration sheet that included the position and state of the veins in the skin, and showed a venous plexus formed by unaccompanied veins in the region immediately below the dermis and within the dermis, the thin vessels ascending from the venous plexus, and the valves present at the bases of these thin vessels, was prepared on the basis of anatomical data about the skin. To supplement this, a 2nd illustration which was an enlarged cross-sectional diagram of the skin and a 3rd illustration were also prepared in the form of sheets. These sheets respectively corresponded to FIG. 1, FIG. 2 and FIG. 4 (of Embodiment 3 but not showing the bones). Twenty students of a school for estheticians were taught the massage treatment method described below, using these illustrations. The practical procedures of this massage treatment were as follows: Firstly, the procedure in which the thin vessels ascending from the venous plexuses formed immediately below the dermis or within the dermis by veins unaccompanied by arteries are pressed towards the deeper part of the skin was performed. After that, the procedure of sequentially pressing the aforesaid venous plexuses towards the veins that drain the blood of the venous plexuses, formed immediately below or within the dermis by veins unaccompanied by arteries, was performed. Finally, the cutaneous veins present in the deep subcutaneous layer were pressed towards the proximal side. Students who were taught the massage treatment with the help of conventionally used structural diagrams of the skin, instead of FIGS. 1, 2 and 4, were designated as a comparison group (n=20). Additionally, a control group (n=20) consisted of students who were taught the massage treatment through oral instruction alone. After explaining the techniques, they were asked to perform the massage on one another and the effect of the massage was evaluated using the hemoglobin oxygen saturation index as the parameter. The hemoglobin oxygen saturation index was calculated using the equation given below from the values obtained in spectral measurements on the skin. The results are given in Table 3. The results clearly show that the use of the illustrations of the present invention enabled many trainees to acquire suitable techniques of providing massage treatment and that the effects of the massage could be obtained with high reproducibility.

Conditions during measurement: Room Temperature (25-26° C.), Relative humidity 50-60%

Measuring device: Minolta Spectrophotometer CM2002

Part where measurements were made

Below the medial angle of the eye

Conditions of Measurement

Two times in C visual field, using the C light source

Three replicate measurements were made at the specified part, using a CM2002 spectrophotometer and the mean values were used.

Method of Analysis

The absorbance was calculated from the reflectance at 400-700 nm measured by CM2002, using Core Science Limited's chroma check software, Sai-Check, and substituted in the Feather's equation to obtain the hemoglobin index (Eq. 1), hemoglobin oxygen saturation index (Eq. 2) and the hemoglobin oxygen saturation (Eq. 3). These equations are given below.
H=[(L544−L527.5)/16.5−(L573−L544)/29]100 (Eq. 1)
OX=[(L573−L558.5)−(L558.5−L544)] 100/14.5H (Eq. 2)
SaO2 (Oxygen saturation %)=(OX+0.821)100/1.97 (Eq. 3)

Here, Lx is the absorbance at x nm, H is the hemoglobin index, and OX is the hemoglobin oxygen saturation index.

TABLE 3

| | Before | |
|---|---|---|
| Group | massage treatment | After massage treatment |
| Group taught as per the | 0.45 ± 0.3 | 0.96 ± 0.3 |
| present invention | | |
| Comparison group | 0.42 ± 0.2 | 0.78 ± 0.7 |
| Control group | 0.43 ± 0.4 | 0.54 ± 0.6 |

### INDUSTRIAL APPLICABILITY

The illustrations of the present invention can be used as teaching materials in general education, such as for teaching natural science, aside from their use in teaching massage treatment, dermatological therapeutic techniques, dermatological diagnostics, etc.

1. Illustrations comprising a first illustration, which displays anatomical characteristics of the skin, including a position and state of cutaneous veins and valves within the veins.

2. Illustrations as in claim 1, wherein said first illustration comprises:
vessels of the subdermal venous plexus formed immediately below the dermis by veins not accompanied by arteries, and thin vessels that ascend from this subdermal venous plexus towards the epidermis, as far as said cutaneous veins are concerned; and
valves present at basal parts of said thin vessels ascending from the subdermal venous plexus, as far as said valves are concerned.

3. Illustrations as in claim 1, wherein said first illustration comprises:
vessels of said subdermal venous plexus formed immediately below the dermis by veins not accompanied by arteries, and the thin vessels that ascend from said subdermal venous plexus towards the epidermis, as far as said cutaneous veins are concerned; and
valves present on the distal side of the branching points of the vessels of said subdermal venous plexus, as far as said valves are concerned.

4. Illustrations as in claim 1, wherein said first illustration comprises:
vessels of the venous plexus formed in a deep dermis by veins not accompanied by arteries, and thin vessels that ascend from said deep dermal venous plexus towards the epidermis, as far as said cutaneous veins are concerned; and valves present at the bases of said thin vessels ascending from said deep dermal venous plexus and on the distal side of the branching points of the vessels of said deep dermal venous plexus, as far as said valves are concerned.

5. Illustrations as in claim 1, wherein the first illustration comprises:
vessels of said deep dermal venous plexus and/or said subdermal venous plexus formed in a deep dermis and/or immediately below the dermis by the veins not accompanied by arteries, and cutaneous veins draining the venous plexus, which extend from the vessels of said deep dermal venous plexus and/or said subdermal venous plexus and join up with the accompanied veins that run side by side with arteries and/or the unaccompanied veins of the deep subcutaneous fat layer, as far as said cutaneous veins are concerned; and
valves on the distal side of the joining points of said cutaneous veins draining the venous plexus with the accompanied veins and/or with the unaccompanied veins in the deep subcutaneous fat layer, as far as said valves are concerned.

6. Illustrations as in claim 1, which comprise a second illustration that gives an enlarged view of anatomical characteristics of the skin, including the position and state of the epidermis, dermis, veins in the region immediately below the dermis and the valves of these veins shown in said 1st illustration.

7. Illustrations as in claim 6, wherein the second illustration comprises:
vessels of said deep dermal venous plexus and/or said subdermal venous plexus formed in the deep dermis and/or immediately below the dermis by the veins not accompanied by arteries, thin vessels of the dermis layer that ascend towards the epidermis from the vessels of said deep dermal venous plexus and/or said subdermal venous plexus, the vessels of the subepidermal plexus of thin veins formed immediately below the epidermis, branching out from said thin vessels of the dermis, and the vessels ascending from the vessels of the subepidermal plexus of veins towards the epidermal papillae, as far as said veins are concerned; and
the valves present at the bases of said thin vessels of the dermis ascending from said deep dermal venous plexus and/or said subdermal venous plexus, as far as said valves are concerned.

8. Illustrations as in claim 1, which comprises a third illustration depicting a position and state of the cutaneous veins and valves in these veins on an external view of the whole or a part of the human body.

9. Illustrations as in claim 1, which comprises a fourth illustration depicting a position and state of lymph vessels on an external view of the whole or a part of the human body.

10. Illustrations as in claim 1, which comprises a fifth illustration depicting a position and state of muscles within the skin and/or in the subcutaneous tissue, On an external view of the whole or a part of the human body.

11. Illustrations as in claim 1, which comprises a sixth illustration depicting positions of acupressure points on an external view of the whole or a part of the human body.

12. Illustrations as claim 1, wherein a position and state of bones beneath the cutaneous tissue are additionally displayed on any of the aforesaid third to sixth illustrations.

13. A method of teaching massage treatment, wherein the illustrations described in claim 1 are used as teaching materials.

14. A method of teaching massage treatment as in claim 13, wherein said massage treatment is configured to improve the circulation of blood that has become stagnant in the skin.

15. A method of teaching massage treatment as in claim 13, wherein said massage treatment comprises a procedure (A) that comprises pressing thin vessels ascending from the deep dermal venous plexus and/or the subdermal venous plexus, which are formed in a deep dermal layer and/or immediately below the dermis by veins unaccompanied by arteries, towards their respective plexuses.

16. A method of teaching massage treatment as in claim 15, wherein said massage treatment comprises a procedure (B) that comprises sequential pressing of the deep dermal venous plexus and/or the subdermal venous plexus towards the cutaneous veins draining the venous plexus, which collect blood from said deep dermal venous plexus and/or the subdermal venous plexus, after the procedure (A).

17. A method of teaching massage treatment as in claim 16, wherein said massage treatment comprises a procedure (C) that comprises pressing of said cutaneous veins draining the venous plexus, towards the proximal side, after said procedures (A) and (B).

18. A method of teaching massage treatment as in claim 17, wherein the procedure (B) is done with a pressure stronger than used in the procedure (A) and the procedure (C) is done with a stronger pressure than the procedure (B).

19. A method of teaching massage treatment as in claim 13, wherein a cream is applied by stroking on the skin surface of the part to be massaged, before or during said procedure (A).

20. A method of teaching massage treatment as in claim 13, which comprises a procedure involving pressing or plucking of the lymph vessels and/or muscles present in the skin or beneath the cutaneous tissue of the part covered by said massage treatment.

21. A method of teaching massage treatment as in claim 1, which comprises a procedure for stimulating the acupressure points located in the skin or below the cutaneous tissue of the part covered by said massage treatment.

22. A method of massage treatment which aims at improving stagnant blood circulation in the skin, on the basis of anatomical characteristics of skin, comprising a position and state of the cutaneous veins and the valves in these veins, and has a procedure (A) that comprises pressing the thin vessels ascending from deep dermal venous plexus and/or the subdermal venous plexus, which are formed in the deep dermal layer or immediately below the dermis by veins unaccompanied by arteries.

23. A method of massage treatment as in claim 22, which comprises a procedure (B) that comprises sequential pressing of the deep dermal venous plexus and/or the subdermal venous plexus towards the direction of the cutaneous veins draining the venous plexus, which collect the blood from said deep dermal venous plexus and/or the subdermal venous plexus after said procedure (A).

24. A method of massage treatment as in claim 23, which comprises a procedure (C) that comprises pressing of said cutaneous veins draining the venous plexus, towards the proximal side after said procedures (A) and (B).

25. A method of massage treatment as in claim 24, wherein the procedure (B) is done with a pressure stronger than used in the procedure (A) and the procedure (C) is done with a stronger pressure than the procedure (B).

26. A method of massage treatment as in claim 22, wherein a cream is applied by stroking on the skin surface of the part to be massaged, before or during said procedure (A).

27. A method of massage treatment as in claim 22, which comprises a procedure involving pressing or plucking of the lymph vessels and/or muscles present in the skin or beneath the cutaneous tissue of the part covered by said massage treatment.

28. A method of massage treatment as in claim 22, which comprises a procedure for stimulating the acupressure points located in the skin or below the cutaneous tissue of the part covered by the massage treatment.

29. A method of teaching massage treatment, wherein the illustrations described in claim 2 are used as teaching materials.

30. A method of teaching massage treatment, wherein the illustrations described in claim 3 are used as teaching materials.

31. A method of teaching massage treatment, wherein the illustrations described in claim 4 are used as teaching materials.

32. A method of teaching massage treatment, wherein the illustrations described in claim 5 are used as teaching materials.

33. A method of teaching massage treatment, wherein the illustrations described in claim 6 are used as teaching materials.

34. A method of teaching massage treatment, wherein the illustrations described in claim 7 are used as teaching materials.

35. A method of teaching massage treatment, wherein the illustrations described in claim 8 are used as teaching materials.

36. A method of teaching massage treatment, wherein the illustrations described in claim 9 are used as teaching materials.

37. A method of teaching massage treatment, wherein the illustrations described in claim 10 are used as teaching materials.

38. A method of teaching massage treatment, wherein the illustrations described in claim 11 are used as teaching materials.

39. A method of teaching massage treatment, wherein the illustrations described in claim 12 are used as teaching materials.
